(19) United States
(12) Patent Application Publication
(10) Pub. No.: US 2026/0278554 A1
(43) Pub. Date: Sep. 17, 2026

(54) AUTOMATING SEARCH AND PERSONALIZED MESSAGING FROM A JOB DESCRIPTION USING A LARGE LANGUAGE MODEL

(71) Applicant: Zipstorm Inc., Bellevue, WA (US)

(72) Inventors: Aravind Bala, Bellevue, WA (US); Joshua Palamuttam, Bellevue, WA (US); John Tippett, Washington, WA (US); Lakshminarasimhan Kasi, Bellevue, WA (US); Ryan Moore, Seatac, WA (US); Narith Hoc, Lynnwood, WA (US); Anushree Hede, State College, PA (US); Saahil Claypool, Boston, MA (US); Nico Nuzzaci, Uppsala (SE); Chihhui Lin, Kirkland, WA (US)

(21) Appl. No.: 19/080,141

(22) Filed: Mar. 14, 2025

(51) Int. Cl. G06Q 10/1053; G06F 16/953; G06F 40/205; G06F 40/289; G06F 40/40

(52) U.S. Cl. CPC G06Q 10/1053; G06F 16/953; G06F 40/205; G06F 40/289; G06F 40/40

(57) ABSTRACT

A method for automating search on a candidate search engine based on a job description to identify a candidate profile having a matching attribute, and generate a personalized message based on the matching attribute are provided. The method includes (i) extracting at least one job requirement and at least one job attribute from the job description in a machine-readable format, (ii) determining at least one suggested keyword associated with the at least one job requirement, (iii) transforming the at least one suggested keyword into at least one substitute term, (iv) generating a search query using at least one of (a) the at least one substitute term or (b) the at least one suggested keyword and execute it to determine at least one matching candidate, (v) determining at least one matching attribute, (vi) extracting the at least one matching candidate preference and (vii) generating and communicating a contextual and personalized message for the at least one matching candidate.

### BACKGROUND

### Technical Field

The embodiments herein generally relate to Large Language Models, and more particularly to a system and a method for automating search on a candidate search engine based on a job description to identify a candidate profile having a matching attribute, and generate a personalized message based on the matching attribute and at least one matching candidate preference.

### Description of the Related Art

One of the key functions in any organization is recruitment. One method for recruitment is outbound recruiting, which involves the steps of writing a job description, searching for candidates from a database to identify relevant candidates, and communicating with the relevant candidates with reference to the job requirement so that the most relevant candidates reply to the message and apply for the job. Job descriptions may be written by recruiters based on input provided by a hiring manager. The job descriptions often include subjective language that is written from the perspective of results or desirable outcomes that are expected from a candidate. The job descriptions also include required and optional skills and qualifications such as educational degrees and years of experience.

The words or phrases used in these subjective descriptions don't translate into useful queries to apply to a job search engine. Also, since companies want to hire the best people, they may include a detailed and exhaustive list of skills, qualifications, and other desirable traits in the job description. It is a hard problem for human recruiters as well as for automated systems to figure out which skills out of the comprehensive list are really needed to fulfill the job requirement, and what queries will return a significant number of relevant results.

Yet another key technical challenge that slows down and affects the quality of the recruitment process is in automating and improving the response rate for messages sent by the recruiters to the matching candidates. Whereas average performers may not receive a lot of messages from recruiters, the top performers and best matches for a job may often receive frequent soliciting messages from recruiters that work for competing companies. Under such circumstances, it is important to write thoughtful and customized messages that catch the attention of the top candidates and improve the chances of receiving a positive response. However, since both quality as well as quantity is important, writing well-thought-out and customized messages to a large number of prospects is cumbersome and time-consuming, and hence slows down the recruitment process substantially.

Existing approaches apply automation only to select aspects of the recruitment process and in a limited manner, and hence fail to address the problem holistically.

### SUMMARY

Embodiments herein provide a system for automating search on a candidate search engine based on a job description to identify a candidate profile having matching attribute. The system includes a memory and a processor. The processor is configured to (A) provide a job description and at least one of (a) a first curated question, (b) a first instruction, or (c) a first exemplary answer to the first curated question to a large language model to extract one or more job requirement and one or more job attribute in a machine-readable format based on a first output obtained from the large language model, (B) determine one or more suggested keyword associated with the one or more job requirement based on the first output from the large language model, (C) transform the one or more suggested keyword into one or more substitute term that preserves the meaning of the one or more suggested keyword, (D) generate a search query using at least one of (a) the one or more substitute term or (b) the one or more suggested keyword and execute the search query on the candidate search engine to determine one or more matching candidate, and (E) extract at least one matching attribute in the search query that is present in the candidate profile by comparing the job requirement that is extracted in the machine readable format with a plurality of candidate attributes in a machine readable format to identify a candidate profile for the job description. The one or more substitute term is more likely to be found in the candidate profile than the one or more suggested keyword. The search query comprises a plurality of search terms separated by Boolean operators.

In some embodiments, the processor is configured to (i) provide the one or more job attribute and the candidate profile of the one or more matching candidate and at least one of (a) a second curated question, (b) a second instruction, or (c) a second exemplary answer to the second curated question to the large language model to extract one or more matching candidate preference based on a second output obtained from the large language model and (ii) generate and communicate a contextual and personalized message for the one or more matching candidate based on the one or more matching attribute and the one or more matching candidate preference.

The processor may generate the first curated question and the second curated questions by parsing the job description and extracting one or more phrases from the job description using the large language model.

The processor may determine the one or more suggested keyword associated with the one or more job requirement by executing the job description and at least one of (a) the first curated question, (b) the first instruction, or (c) the first exemplary answer to the first curated question on the large language model. The large language model determines the one or more suggested keyword from the one or more job requirement using an answer to the first curated question that is generated based on the first instruction and the first exemplary answer to the first curated question provided to the large language model. The one or more suggested keyword may define at least one of a required skill or a preferred skill.

In some embodiments, the processor determines the one or more substitute term for the one or more suggested keyword by (A) extracting one or more sentence from the job description, (B) extracting one or more noun phrase from the one or more sentence, (C) determining a phrase that is related to knowledge-based abilities by removing a phrase that is related to at least one of a degree, a relevant experience, a soft skill, a job title, an action verb, or a company and an organization and (D) grouping similar phrases related to the knowledge-based abilities to determine the one or more substitute term and combining them using a Boolean expression to generate the search query.

The processor may generate the search query using the one or more suggested keyword, and the one or more substitute term. The processor is configured to generate the search query using the at least one suggested keyword and/or the one or more substitute term based on at least one of (a) a number of occurrences of the one or more substitute term in a corpus, the candidate profile, the job description or (b) a number of occurrences of the one or more substitute term in a recruiter input.

In some embodiments, the processor generates the contextual message by (a) providing (i) the candidate profile of the one or more matching candidate, (ii) at least one of (A) the first curated question, (B) the first instruction, or (C) the first exemplary answer to the first curated question, and (iii) at least one of (A) the one or more suggested keyword or (B) the one or more substitute term extracted from the one or more job requirement to the large language model, (b) determining, using the large language model, the one or more matching attribute by identifying one or more keywords from the candidate profile of the one or more matching candidate that is matched with at least one of (A) the one or more suggested keyword or (B) the one or more substitute term extracted from the one or more job requirement and (c) generating the contextual message based on the one or more matching attribute including (A) the one or more keyword or (B) one or more the substitute term extracted from the one or more job requirement that is matched with the one or more keywords extracted from the candidate profile of the one or more matching candidate.

The processor may extract the one or more matching candidate preference by (A) analyzing the candidate profile of the one or more matching candidate to identify one or more keywords present in the candidate profile of the one or more matching candidate that is matched with at least one of (a) one or more keyword or (b) one or more substitute term extracted from the one or more job attribute, (B) extracting, using the large language model, one or more phrases from the candidate profile of the one or more matching candidate based on the one or more keywords present in the candidate profile of the one or more matching candidate and (C) extracting the one or more matching candidate preference from the candidate profile of the one or more matching candidate by identifying a matching candidate preference present in the candidate profile of the one or more matching candidate that is matched with at least one of (a) the one or more keyword or (b) the one or more substitute term extracted from the one or more job attribute.

In some embodiments, the processor generates the personalized message by (i) analyzing the candidate profile of the one or more matching candidate to identify the one or more matching candidate preference present in the candidate profile of the one or more matching candidate that is matched with the one or more job attribute, (ii) extracting at least one of (a) a term, (b) a phrase, or (c) a sentence from the candidate profile of the one or more matching candidate based on the one or more matching candidate preference that is identified and (iii) generating the personalized message on (A) how the candidates are suited for a target position associated with the job description using at least one of (a) the one or more suggested keyword or (b) the one or more substitute term extracted from the one or more job requirement and (B) how the target position is matched with the one or more matching candidate preference using at least one of (a) the term, (b) the phrase, or (c) the sentence extracted from the candidate profile of the one or more matching candidate.

In another aspect, a computer-implemented method for automating search on a candidate search engine based on a job description to identify a candidate profile having matching attribute is provided. The computer-implemented method includes (A) providing a job description and at least one of (a) a first curated question, (b) a first instruction, or (c) a first exemplary answer to the first curated question to a large language model to extract one or more job requirement and one or more job attribute in a machine-readable format based on a first output obtained from the large language model, (B) determining one or more suggested keyword associated with the one or more job requirement based on the first output from the large language model, (C) transforming the one or more suggested keyword into one or more substitute term that preserves the meaning of the one or more suggested keyword, (D) generating a search query using at least one of (a) the one or more substitute term or (b) the one or more suggested keyword and execute the search query on the candidate search engine to determine one or more matching candidate, wherein the search query comprises a plurality of search terms separated by Boolean operators, (E) extracting at least one matching attribute in the search query that is present in the candidate profile by comparing the job requirement that is extracted in the machine readable format with a plurality of candidate attributes in a machine readable format to identify a candidate profile for the job description. The one or more substitute term is more likely to be found in the candidate profile than the one or more suggested keyword.

The computer-implemented method includes (i) providing the one or more job attribute and the candidate profile of the one or more matching candidate and at least one of (a) a second curated question, (b) a second instruction, or (c) a second exemplary answer to the second curated question to the large language model to extract one or more matching candidate preference based on a second output obtained from the large language model and (ii) generating and communicating a contextual and personalized message for the one or more matching candidate based on the one or more matching attribute and the one or more matching candidate preference.

The one or more substitute term for the one or more suggested keyword may be determined by (A) extracting one or more sentence from the job description, B) extracting one or more noun phrase from the one or more sentence, (C) determining a phrase that is related to knowledge-based abilities by removing a phrase that is related to at least one of a degree, a relevant experience, a soft skill, a job title, an action verb, or a company and an organization; and (D) grouping similar phrases related to the knowledge-based abilities to determine the one or more substitute term and combining them using a Boolean expression to generate the search query.

In some embodiments, the search query is generated using at least one of (i) the at least one suggested keyword or (ii) the one or more substitute term based on at least one of (a) a number of occurrences of the one or more substitute term in a corpus, the candidate profile, the job description or (b) a number of occurrences of the one or more substitute term in a recruiter input.

The contextual message may be generated by (A) providing (i) the candidate profile of the one or more matching candidate, (ii) at least one of (a) the first curated question, (b) the first instruction, or (c) the first exemplary answer to the first curated question, and (iii) at least one of (a) the one or more suggested keyword or (b) the one or more substitute term extracted from the one or more job requirement to the large language model, (B) determining, using the large language model, the one or more matching attribute by identifying one or more keywords from the candidate profile of the one or more matching candidate that is matched with at least one of (a) the one or more suggested keyword or (b) the one or more substitute term extracted from the one or more job requirement and (C) generating the contextual message based on the one or more matching attribute including (a) the one or more keyword or (b) one or more the substitute term extracted from the one or more job requirement that is matched with the one or more keywords extracted from the candidate profile of the one or more matching candidate.

The one or more matching candidate preference may be extracted by (A) analyzing the candidate profile of the one or more matching candidate to identify one or more keywords present in the candidate profile of the one or more matching candidate that is matched with at least one of (a) one or more keyword or (b) one or more substitute term extracted from the one or more job attribute, (B) extracting, using the large language model, one or more phrases from the candidate profile of the one or more matching candidate based on the one or more keywords present in the candidate profile of the one or more matching candidate and (C) extracting the one or more matching candidate preference from the candidate profile of the one or more matching candidate by identifying a matching candidate preference present in the candidate profile of the one or more matching candidate that is matched with at least one of (a) the one or more keyword or (b) the one or more substitute term extracted from the one or more job attribute.

In some embodiments, the personalized message is generated by (i) analyzing the candidate profile of the one or more matching candidate to identify the one or more matching candidate preference present in the candidate profile of the one or more matching candidate that is matched with the one or more job attribute, (ii) extracting at least one of (a) a term, (b) a phrase, or (c) a sentence from the candidate profile of the one or more matching candidate based on the one or more matching candidate preference that is identified and (iii) generating the personalized message on (A) how the candidates are suited for a target position associated with the job description using at least one of (a) the one or more suggested keyword or (b) the one or more substitute term extracted from the one or more job requirement and (B) how the target position is matched with the one or more matching candidate preference using at least one of (a) the term, (b) the phrase, or (c) the sentence extracted from the candidate profile of the one or more matching candidate.

In another aspect, one or more non-transitory computer readable storage mediums storing one or more sequences of instructions for automating search on a candidate search engine based on a job description to identify a candidate profile having a matching attribute which when executed by one or more processors, cause (A) providing a job description and at least one of (a) a first curated question, (b) a first instruction, or (c) a first exemplary answer to the first curated question to a large language model to extract one or more job requirement and one or more job attribute in a machine-readable format based on a first output obtained from the large language model, (B) determining one or more suggested keyword associated with the one or more job requirement based on the first output from the large language model, (C) transforming the one or more suggested keyword into one or more substitute term that preserves the meaning of the one or more suggested keyword, (D) generating a search query using at least one of (a) the one or more substitute term or (b) the one or more suggested keyword and execute the search query on the candidate search engine to determine one or more matching candidate, wherein the search query comprises a plurality of search terms separated by Boolean operators, (E) extracting at least one matching attribute in the search query that is present in the candidate profile by comparing the job requirement that is extracted in the machine readable format with a plurality of candidate attributes in a machine readable format to identify a candidate profile for the job description. The one or more non-transitory computer readable storage mediums further causes (i) providing the one or more job attribute and the candidate profile of the one or more matching candidate and at least one of (a) a second curated question, (b) a second instruction, or (c) a second exemplary answer to the second curated question to the large language model to extract one or more matching candidate preference based on a second output obtained from the large language model and (ii) generating and communicating a contextual and personalized message for the one or more matching candidate based on the one or more matching attribute and the one or more matching candidate preference. The one or more substitute term is more likely to be found in the candidate profile than the one or more suggested keyword.

The one or more substitute term for the one or more suggested keyword may be determined by (A) extracting one or more sentence from the job description, (B) extracting one or more noun phrase from the one or more sentence, (C) determining a phrase that is related to knowledge-based abilities by removing a phrase that is related to at least one of a degree, a relevant experience, a soft skill, a job title, an action verb, or a company and an organization and (D) grouping similar phrases related to the knowledge-based abilities to determine the one or more substitute term and combining them using a Boolean expression to generate the search query.

In some embodiments, the contextual message is generated by (A) providing (i) the candidate profile of the one or more matching candidate, (ii) at least one of (a) the second curated question, (b) the second instruction, or (c) the second exemplary answer to the second curated question, and (iii) at least one of (a) the one or more suggested keyword or (b) the one or more substitute term extracted from the one or more job requirement to the large language model, (B) determining, using the large language model, the one or more matching attribute by identifying one or more keywords from the candidate profile of the one or more matching candidate that is matched with at least one of (a) the one or more suggested keyword or (b) the one or more substitute term extracted from the one or more job requirement and (C) generating the contextual message based on the one or more matching attribute including (a) the one or more keyword or (b) one or more the substitute term extracted from the one or more job requirement that is matched with the one or more keywords extracted from the candidate profile of the one or more matching candidate.

The one or more matching candidate preference may be extracted by (A) analyzing the candidate profile of the one or more matching candidate to identify one or more keywords present in the candidate profile of the one or more matching candidate that is matched with at least one of (a) one or more keyword or (b) one or more substitute term extracted from the one or more job attribute, (B) extracting, using the large language model, one or more phrases from the candidate profile of the one or more matching candidate based on the one or more keywords present in the candidate profile of the one or more matching candidate and (C) extracting the one or more matching candidate preference from the candidate profile of the one or more matching candidate by identifying a matching candidate preference present in the candidate profile of the one or more matching candidate that is matched with at least one of (a) the one or more keyword or (b) the one or more substitute term extracted from the one or more job attribute.

In some embodiments, the personalized message is generated by (i) analyzing the candidate profile of the one or more matching candidate to identify the one or more matching candidate preference present in the candidate profile of the one or more matching candidate that is matched with the one or more job attribute, (ii) extracting at least one of (a) a term, (b) a phrase, or (c) a sentence from the candidate profile of the one or more matching candidate based on the one or more matching candidate preference that is identified and (iii) generating the personalized message on (A) how the candidates are suited for a target position associated with the job description using at least one of (a) the one or more suggested keyword or (b) the one or more substitute term extracted from the one or more job requirement and (B) how the target position is matched with the one or more matching candidate preference using at least one of (a) the term, (b) the phrase, or (c) the sentence extracted from the candidate profile of the one or more matching candidate.

### BRIEF DESCRIPTION OF THE DRAWINGS

The embodiments herein will be better understood from the following detailed description with reference to the drawings, in which:

FIG. 1 is a system view of an automated search and personalized messaging system for automating search on a candidate search engine based on a job description to identify a candidate profile having matching attribute, and generate a personalized message based on the matching attribute and one or more matching candidate preference according to some embodiments herein;

FIG. 2 illustrates an exploded view of an automated search and personalized messaging system according to some embodiments herein;

FIGS. 3A-3B illustrate exemplary user interfaces of the automated search and personalized messaging system for receiving recruiter inputs according to some embodiments herein;

FIGS. 4A-4B illustrate exemplary user interfaces of an automated search and personalized messaging system for providing one or more preferences to determine one or more matching candidate for a target position according to some embodiments herein;

FIG. 5 illustrates an exemplary user interface of the automated search and personalized messaging system for recommending a contextual message and a personalized message for the one or more matching candidate for the target position according to some embodiments herein;

FIGS. 6A-6D illustrate exemplary user interfaces of an automated search and personalized messaging system for automating search on a candidate search engine based on a job description to identify a candidate profile having matching attribute, and generate a personalized message based on the matching attribute according to some embodiments herein;

FIG. 7 is an exemplary flow diagram of determining one or more substitute term for one or more suggested keyword extracted from a job description according to some embodiments herein;

FIG. 8 is an exemplary flow diagram of generating a contextual and personalized message according to some embodiments herein;

FIG. 9 is a flow diagram that illustrates a method for automating search, identifying relevant candidates, and generating personalized messages using large language models according to some embodiments herein;

FIG. 10 illustrates an exploded view of a computing device according to some embodiments herein; and

FIG. 11 is a schematic diagram of a computer architecture in accordance with the embodiments herein.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

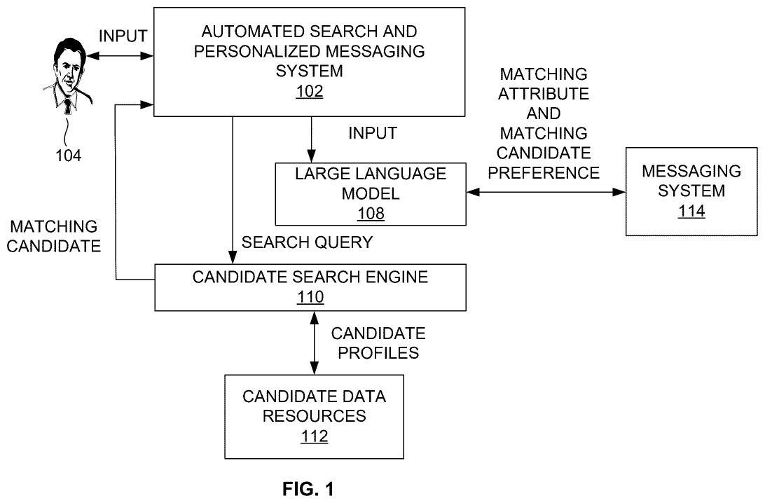

As mentioned, there remains a need for a system and a method for determining and contacting potential candidates for a target position. Referring now to the drawings, and more particularly to FIGS. 1 to 11, where similar reference characters denote corresponding features consistently throughout the figures, there are shown preferred embodiments.

FIG. 1 is a system view of an automated search and personalized messaging system for automating search on a candidate search engine based on a job description to identify a candidate profile having matching attribute, and generate a personalized message based on the matching attribute and matching candidate preferences according to some embodiments herein. The system view 100 includes an automated search and personalized messaging system 102, a large language model 106, a candidate search engine 108, a candidate data resources 110 and a messaging system 112. The automated search and personalized messaging system 102 may be connected to a world wide web. The automated search and personalized messaging system 102 may connect with the large language model 108 using the world wide web. In some embodiments, the automated search and personalized messaging system 102 communicates with at least one of a recruiter device of the recruiter 104, the large language model 106, the candidate search engine 108, the candidate resources 110 or the messaging system 112 using a network. The automated search and personalized messaging system 102 receives one or more input associated with a target position from the recruiter device. The one or more input may include a job description and at least one of (a) a first curated question and a second curated question, (b) a first instruction and a second instruction, or (c) a first exemplary answer to the first curated question and a second exemplary answer and the second curated question. In some embodiments, the automated search and personalized messaging system 102 receives at least one of unstructured data inputs or natural language inputs. The automated search and personalized messaging system 102 may generate one or more curated questions for a received job description. The automated search and personalized messaging system 102 may parse the received job description to extract phrases and generate the curated questions.

The large language model 108 receives a first input from the automated search and personalized messaging system 102 and executes to generate a first output. The first input may include the job description and at least one of (a) the first curated question, (b) the first instruction, or (c) the first exemplary answer to the first curated question. The first output may include at least one of company profile who has posted the job description, required skills, preferred skills, titles, or a job location. The first output may be generated using an answer to the first curated question that is generated based on the first instruction and the first exemplary answer to the first curated question provided to the large language model 108. The automated search and personalized messaging system 102 extracts a job requirement and a job attribute from the job description in a machine-readable format (e.g., a JSON format) based on the first output obtained from the large language model 108. The job requirement may include skills or qualification that are required for the job. The job attribute may include an attribute that the company offers to the candidate and the candidate expects from the company. The large language model 108 determines a suggested keyword associated with the job requirement based on the first output. The large language model 108 may determine the suggested keyword that is relevant to the target position by executing at least one of (a) the first curated question, (b) the first instruction, or (c) the first exemplary answer to the first curated question. The suggested keyword defines at least one of the required skills or preferred skills. The curated questions help to determine the suggested keyword associated with required and preferred keywords for the target position. In some embodiments, the required and preferred keywords are related to at least one of a company profile, required skills, titles, or a job location associated with the target position. The automated search and personalized messaging system 102 may refine the suggested keyword to identify matching candidates.

The automated search and personalized messaging system 102 transforms the suggested keyword into a substitute term that preserves the meaning of the suggested keyword. The substitute term is more likely to be found in the candidate profile than the suggested keyword. The automated search and personalized messaging system 102 generates a search query using at least one of (a) the substitute term or (b) suggested keyword and execute the search query on the candidate search engine 110 to determine the matching candidates. The search query includes a plurality of search terms separated by Boolean operators. In some embodiments, the candidate search engine 110 is connected with the candidate date resources 112. The candidate search engine 110 may extract candidate details from at least one of the candidate data resources 112. The search query may include at least one of titles, skills, locations, certificates, years of experience, a previous experience, or an educational background. The automated search and personalized messaging system 102 generates the search query using at least one of Boolean operators. In some embodiments, the search query is mapped to a recruiter ID associated with the recruiter 104. The automated search and personalized messaging system 102 may enable the recruiter 104 to customize the search query. In some embodiments, the automated search and personalized messaging system 102 customizes the search query using a search simulator.

The automated search and personalized messaging system 102 extracts at least one matching attribute in the search query that is present in the candidate profile by comparing the job requirement that is extracted in the machine readable format with a plurality of candidate attributes in a machine readable format to identify a candidate profile for the job description. The automated search and personalized messaging system 102 extracts a matching attribute for the matching candidates by executing at least one of (a) the second curated question, (b) the second instruction, or (c) the second exemplary answer to the second curated question on the large language model 108. In some embodiments, the large language model 108 generates a second output using the candidate profile that is matched with the job attribute and at least one of (a) the second curated question, (b) the second instruction, or (c) the second exemplary answer to the second curated question and extracts one or more matching candidate preference based on the second output obtained from the large language model. The second output may include the matching candidate preference in at least one of the job attribute and the candidate profile of the matching candidates. The matching attribute may include a title, a skill, a location, a certificate, years of experience, a previous experience, or an educational background provided in the job requirement that is matched in the candidate profile of the matching candidates. The matching candidate preference may include at least one of hard skills, soft skills, or an experience that is provided on the candidate profile of the matching candidates that is matched with at least one of (a) one or more keyword or (b) one or more substitute term extracted from the job attribute.

The automated search and personalized messaging system 102 provides (a) the matching candidates, (b) the matching attribute, and (c) the matching candidate preference to the messaging system 114. The messaging system 114 generates and communicates a contextual and personalized message for the matching candidates based on the matching attribute and the matching candidate preference. The messaging system 114 generates a personalized message for each candidate from the matching candidates on how the candidate is suited for the target position and how the target position is matched with the candidate's preferences and communicates to the corresponding candidate using the messaging system 114. The automated search and personalized messaging system 102 may include at least one of a machine learning model or data processing algorithms to determine and contact the matching candidates for the target position.

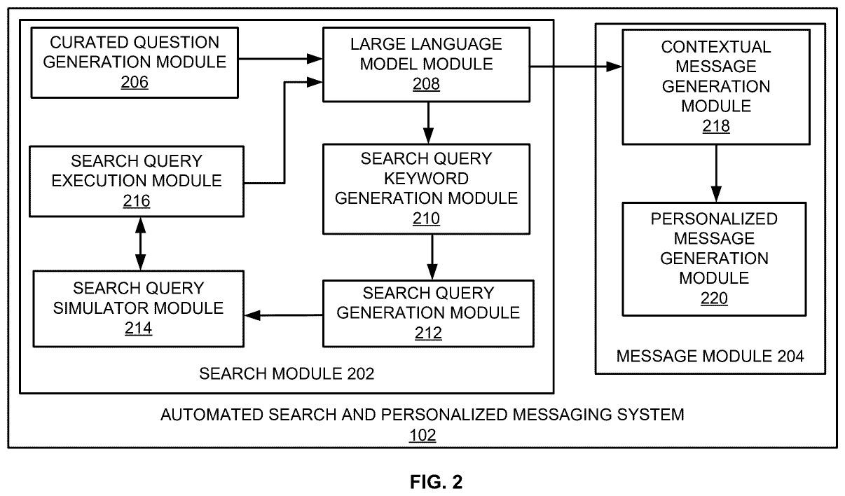

With reference to FIG. 1, FIG. 2 illustrates an exploded view of the automated search and personalized messaging system 102 according to some embodiments herein. The automated search and personalized messaging system 102 includes a search module 202 and a message module 204. The search module 202 includes a curated question generation module 206, a large language model module 208, a search query keyword generation module 210, a search query generation module 212, a search query simulator module 214 and a search query execution module 216. The message module 204 includes a contextual message generation module 218 and a personalized message generation module 220. The search module 202 extracts the phrases by parsing a job description provided by the recruiter 104. In some embodiments, the job description includes keywords that are related to at least one of a company profile, required skills, titles, or a job location associated with a target position. The job description may include job requirement and job attribute. The curated question generation module 206 generates at least one of (a) a first curated question and a second curated question, (b) a first instruction and a second instruction, or (c) a first exemplary answer to the first curated question and a second exemplary answer to the second curated question of the received job description. The curated question generation module 206 communicates at least one of (a) the first curated question and the second curated question, (b) the first instruction and the second instruction, or (c) the first exemplary answer to the first curated question and the second exemplary answer to the second curated question to the large language model 108 to determine one or more suggested keywords associated with the job requirement based on a first output from the large language model. In some embodiments, the suggested keyword is related to the company profile, the required skills, the titles, educational backgrounds, previous work experience or the job location associated with the job description of the target position. The search query keyword generation module 210 receives the suggested keyword from the large language model 108. The suggested keyword associated with the job requirement may be determined by executing the job description and at least one of (a) the first curated question, (b) the first instruction, or (c) the first exemplary answer to the first curated question on the large language model 108. The suggested keyword defines at least one of the required skills or preferred skills. In some embodiments, the first or second curated question is used to determine at least one of required keywords and preferred keywords from the job requirement. The at least one of the required keywords and the preferred keywords may include at least one of a company profile, required skills, titles, or a job location associated with the target position. The search query keyword generation module 210 transforms the suggested keyword into a substitute term that preserves the meaning of the suggested keyword.

The search query generation module 212 generates a search query using at least one of (a) the substitute term or (b) the suggested keyword. The search query may include at least one of the titles, the skills, the locations, the certificates, the years of experience, the previous experience, or the educational background associated with the job description. The search query may include search terms separated by Boolean operators. In some embodiments, the search query generation module 212 maps the search query to a recruiter ID associated with the recruiter 104. The search query generation module 212 may provide the search query to the search query simulator module 214 to enable search query customization. The search query simulator module 214 customizes the search query keywords using the large language model 108. The search query simulator module 214 provides the job description, and at least one of (a) the first curated question, (b) the first instruction, or (c) the first exemplary answer to the first curated question to the large language model 108 to determine new search query keywords that are similar to the previously generated search query keywords. The search query execution module 216 executes the search query on the candidate search engine 110 to determine matching candidates. In some embodiments, the candidate search engine 110 extracts the matching candidate from candidate data resources 112. The search query execution module 216 provides the matching candidates to the large language model module 208 which extracts at least one matching attribute in the search query that is present in the candidate profile by comparing the job requirement that is extracted in the machine readable format with a plurality of candidate attributes in a machine readable format to identify a candidate profile for the job description. The search query execution module 216 provides the job attribute and the candidate profile of the matching candidate and at least one of (a) the second curated question, (b) the second instruction, or (c) the second exemplary answer to the second curated question to the large language model module 208 to extract one or more matching candidate preference based on a second output obtained from the large language model module 208.

The message module 204 receives the one or more matching attribute and the matching candidate preference from the search module 202. The contextual message generation module 218 and the personalized message generation module 220 generate and communicate a contextual and personalized message to the matching candidates based on the matching attribute and the one or more matching candidate preference. In some embodiments, the contextual message generation module 218 generates the contextual message by analyzing a candidate profile of the matching candidates with the job requirement, and at least one of (a) the substitute term or (b) the suggested keyword. The contextual message generation module 218 may analyze the candidate profile of the matching candidates with the at least one of required skills or preferred skills that are determined using the large language model 108 to determine the contextual message.

In some embodiments, the personalized message includes how the candidates are suited for the target position and how the target position is matched with the candidate's preferences.

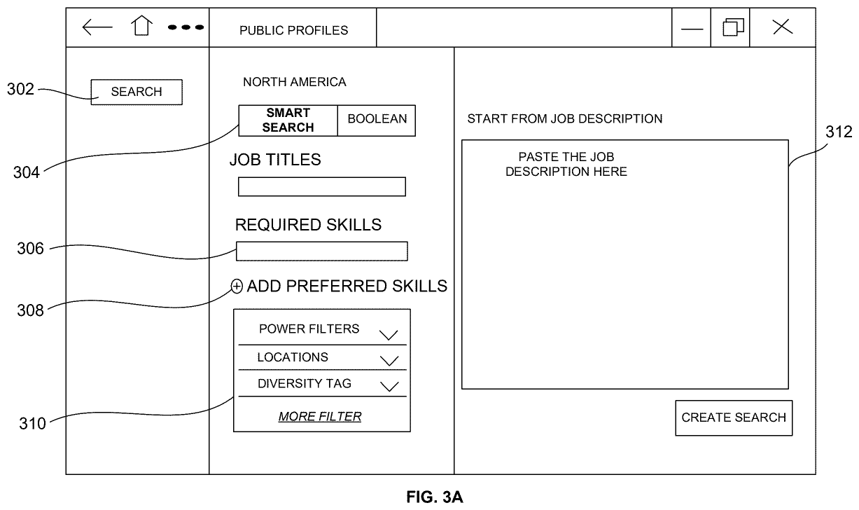

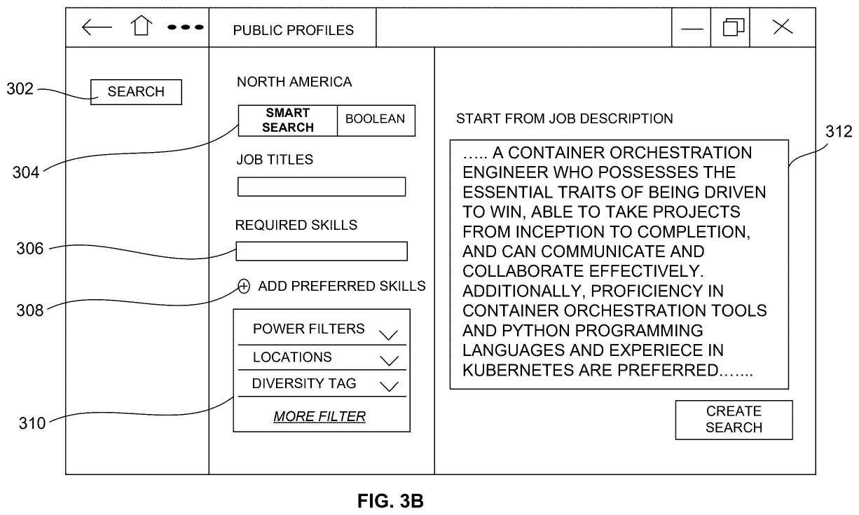

With reference to FIG. 1, FIGS. 3A-3B illustrate exemplary user interfaces of the automated search and personalized messaging system 102 for receiving recruiter inputs according to some embodiments herein. The exemplary user interfaces of the automated search and personalized messaging system 102 includes a search tab 302, a smart search tab 304, a required skills tab 306, a preference adding option 308, filters 310, and a job description dialog box 312. The recruiter 104 selects the search tab 302 and the smart search tab 304 to provide a job description for a target position (e.g. container orchestration) on the job description dialog box 312. In some embodiments, the job description is prepared by the recruiter 104. The automated search and personalized messaging system 102 enables the recruiter 104 to paste or upload the job description on the job description dialog box 312. The job description may include at least one of a company profile, required skills, titles, or a job location associated with the target position. For example, the job description for the target position includes at least one of the preferred soft skills and hard skills, the educational background, the previous experience requirements, special certifications, and location details of the target position. The automated search and personalized messaging system 102 parses the job description into the queries. The queries are used to determine the suggested keywords using the large language model 108. The suggested keywords are related to the company profile, the required skills, the titles, the educational backgrounds, the previous work experience, or the job location that are associated with the job description of the target position. In some embodiments, the automated search and personalized messaging system 102 enables the recruiter 104 to drag and drop or copy and paste the job description of the target position on the job description dialog box 312. The automated search and personalized messaging system 102 may provide entertainment content while the queries are processed with the large language model 108.

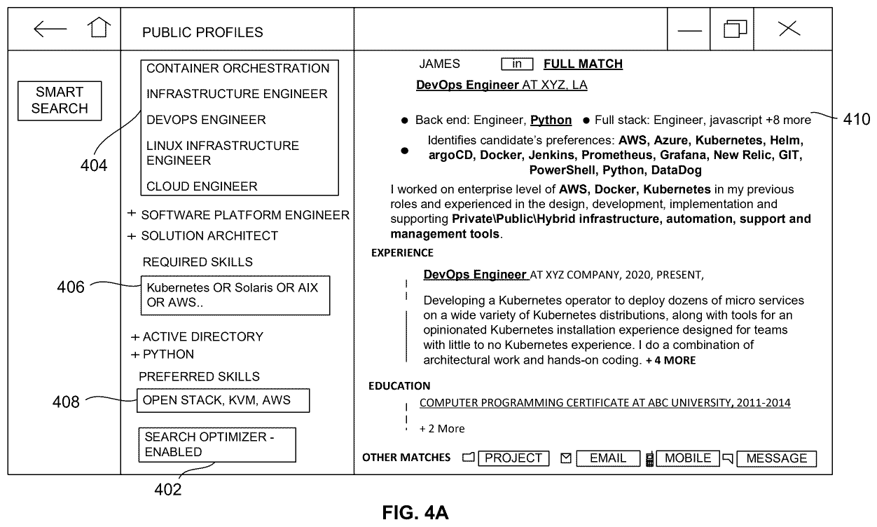

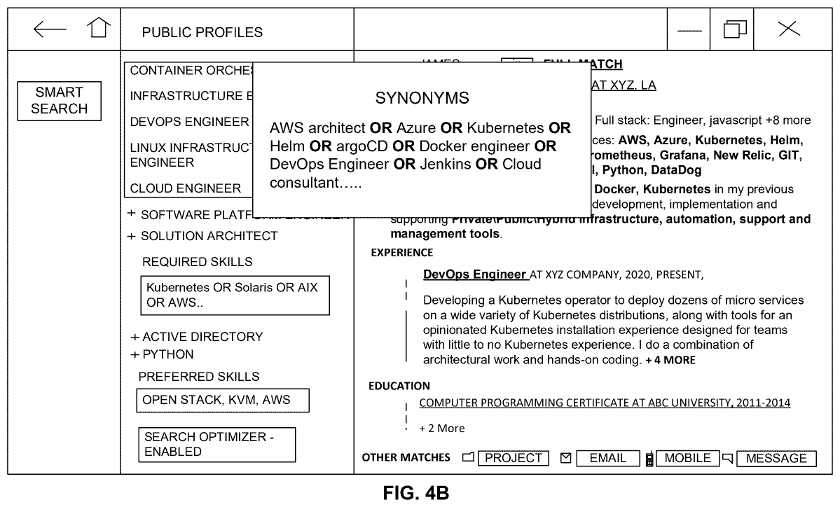

With reference to FIG. 1, FIGS. 4A-4B illustrate exemplary user interfaces of the automated search and personalized messaging system 102 for providing preferences to determine matching candidate for a target position according to some embodiments herein. The automated search and personalized messaging system 102 determines suggested keyword that are similar to the required skills provided in the job description of the target position. The automated search and personalized messaging system 102 enables the recruiter 104 to select or deselect at least one of the required keywords or the relevant keywords from the suggested keyword. The automated search and personalized messaging system 102 transforms the suggested keyword into substitute term that preserves the meaning of the one or more suggested keyword. The substitute term is more likely to be found in the candidate profile than the suggested keyword. The automated search and personalized messaging system 102 generates the search query using at least one of (a) the substitute term or (b) the suggested keyword and executed the search query on a candidate search engine to determine matching candidates. In some embodiments, the automated search and personalized messaging system 102 enables the recruiter 104 to enable the search simulator to customize the search query to identify the matching candidates. The search simulator is enabled by clicking the search optimizer option 402. The search simulator may provide the first curated question and the job description to the large language model 108 to refine the at least one of (a) the substitute term or (b) the suggested keyword. In some embodiments, the automated search and personalized messaging system 102 enables the recruiter 104 to implement the Boolean operators to generate the search query. The automated search and personalized messaging system 102 executes the search query on the candidate search engine 110 to determine the matching candidates for the target position.

For example, the FIGS. 4A and 4B depict a candidate profile for a target position of container orchestration at BBB company, Los angles. The automated search and personalized messaging system 102 transforms suggested keyword of a job description of the container orchestration position into substitute term that preserves the meaning and are more likely to be found in candidate profiles than the suggested keyword 404. The suggested keyword 404 includes keywords that are similar to the container orchestration position, for example, infrastructure engineer, DevOps Engineer, etc. The automated search and personalized messaging system 102 determines required skills 406 (e.g. at least one of Kubernetes, python, solaris, AIX, AWS, etc.) that are related to the container orchestration position from the job description. The automated search and personalized messaging system 102 determines preferred skills 408 (e.g. at least one of Open stack, Linux, KVM, AWS, etc.) that are related to the container orchestration position from the job description. The automated search and personalized messaging system 102 identifies a matching candidate profile 410 for the container orchestration position by generating a search query using at least one of (a) the substitute term or (b) the suggested keyword (i.e. required, relevant, or synonym keywords/skills associated with the job description). The automated search and personalized messaging system 102 executes the search query on the candidate search engine 110 to determine matching candidates for the container orchestration position. The candidate profile 410 of the potential candidates includes at least one of skills, a certification, an experience, an educational background, or a career summary. The automated search and personalized messaging system 102 identifies the matched skills, experience, certification, or other parameters to determine the matching candidate for the container orchestration position and to generate a personalized message for the matching candidates.

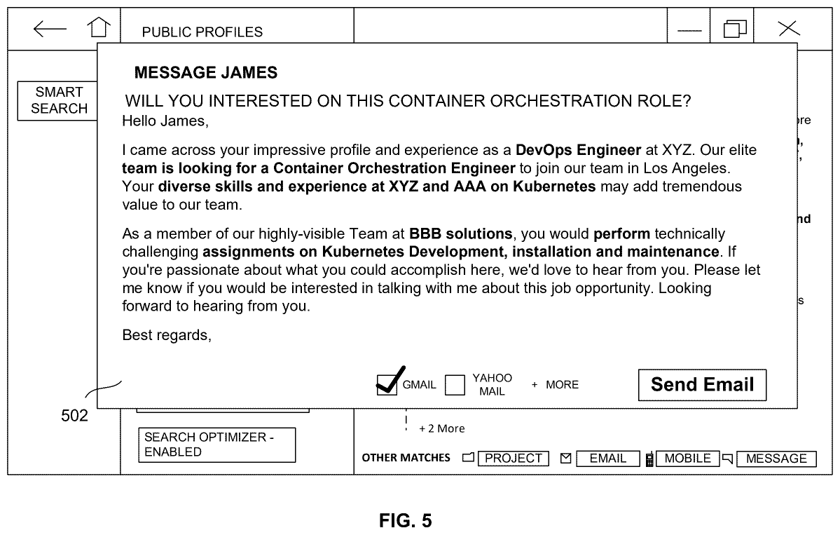

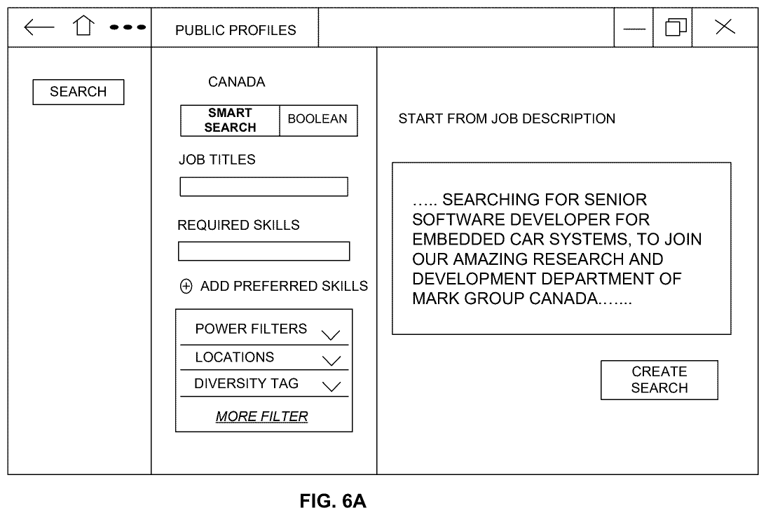

With reference to FIGS. 4A and 4B, FIG. 5 illustrates an exemplary user interface of the automated search and personalized messaging system 102 for recommending a contextual and a personalized message for the matching candidates for the target position (e.g. container orchestration position) according to some embodiments herein. The automated search and personalized messaging system 102 analyses a profile of the matching candidates with job requirements associated with the job description, and the suggested keyword to generate the contextual message. In some embodiments, the contextual message describes how the matching candidates are suited for the target position. The candidate's profile of the matching candidates includes at least one of a profile, an experience, skills, languages known, or an educational background. The automated search and personalized messaging system 102 determines at least one of hard skills, soft skills, or experience using at least one of the profile, the experience, the skills, the languages known, or the educational background. The hard skills, soft skills, and experience of the matching candidates are then matched with matching attribute and the one or more matching candidate preference that are determined using the large language model 108 for generating the contextual message. One such contextual message may be, for example “I came across your impressive profile and experience as a DevOps Engineer at XYZ. Our elite team is looking for a Container Orchestration Engineer to join our team in Los Angeles. Your diverse skills and experience at XYZ and AAA on Kubernetes may add tremendous value to our team”.

The automated search and personalized messaging system 102 generates a personalized message for the matching candidates. In some embodiments, the personalized message includes information related to how the candidates are suited for the target position and how the target position is matched with the matching candidate preferences of the candidate.

For example, the automated search and personalized messaging system 102 generates a personalized message 502 for the matching candidates for the container orchestration position. The personalized message 502 highlights the information related to how the matching candidates have suited for the target container orchestration position and how the target position is matched with the matching candidate preferences that are extracted from the candidate profile of the matching candidates.

The automated search and personalized messaging system 102 provides options to the recruiter 104 for customizing the personalized message further. The automated search and personalized messaging system 102 provides options to highlight one or more parameters of the match summary. In some embodiments, the matching candidate preferences include at least one of the hard skills, the soft skills, or the experience that is provided on the candidate profile of the matching candidates.

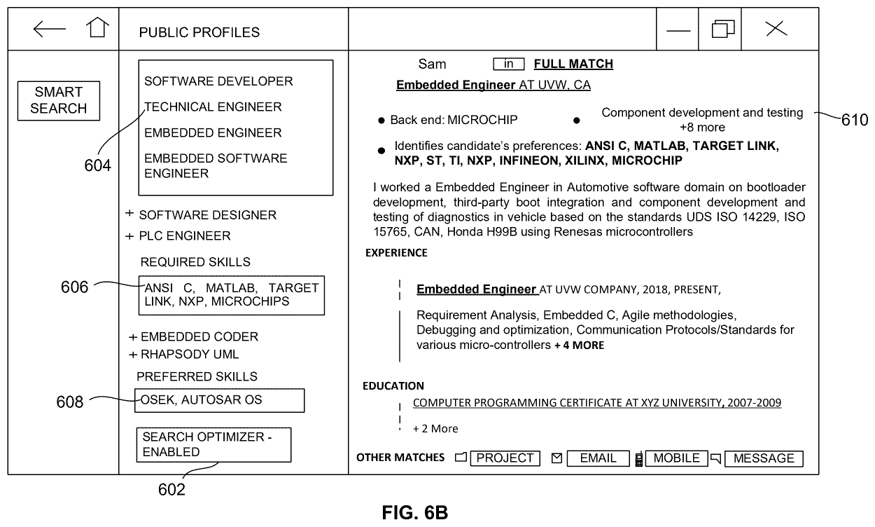

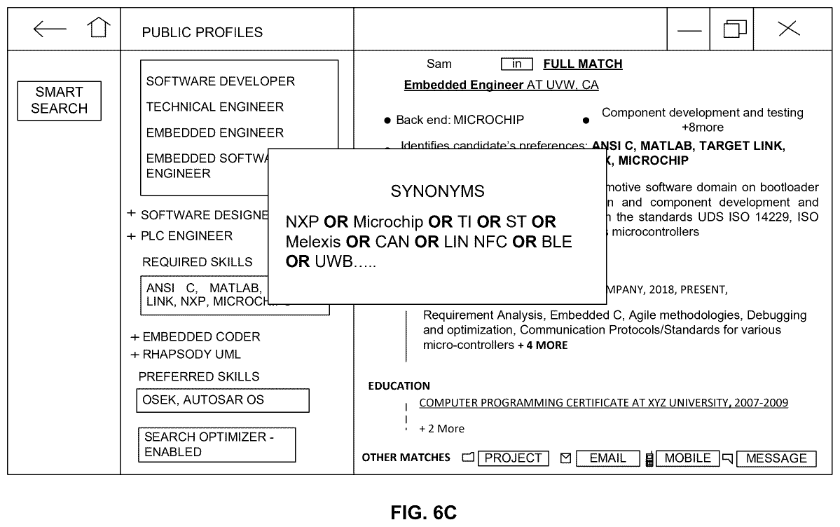

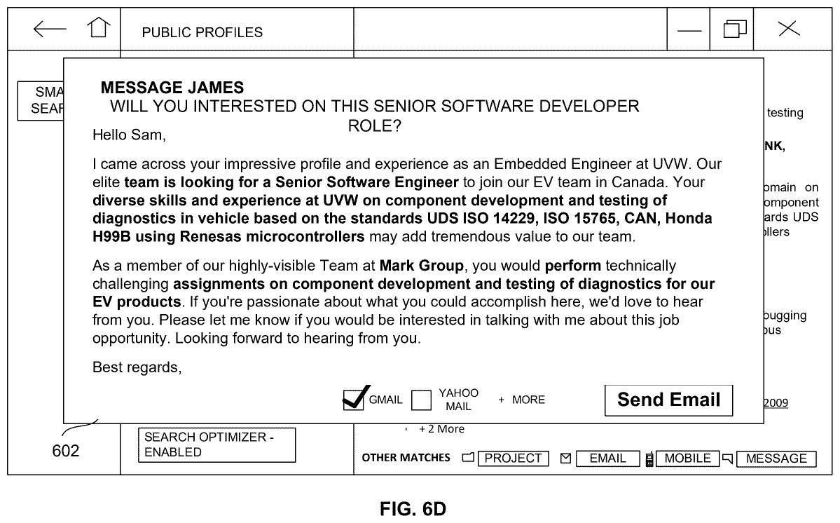

With reference to FIG. 1 to FIG. 5, FIGS. 6A-6D illustrate exemplary user interfaces of the automated search and personalized messaging system 102 for automating search on the candidate search engine 110 based on a job description to identify a candidate profile having matching attribute, and generate a personalized message based on a matching attribute and a matching candidate preference according to some embodiments herein. For example, the FIGS. 6A-6C depicts a candidate profile of matching candidates for a target position of senior software engineer at Mark group, Canada. The automated search and personalized messaging system 102 transforms suggested keywords 604 of a job description of the senior software engineer position into substitute terms that preserve the meaning and are more likely to be found in candidate profiles. The suggested keywords 604 include keywords that are similar to the senior software engineer position, for example, software engineer, technical Engineer, etc. The automated search and personalized messaging system 102 determines required skills 606 (e.g. at least one of ANSI C, MATLAB, TARGET LINK, NXP, MICROCHIPS, etc.) that are related to the senior software engineer position from the job description. The automated search and personalized messaging system 102 determines preferred skills 608 (e.g. at least one of OSEK, AUTOSAR OS, etc.) that are related to the senior software engineer position from the job description. The automated search and personalized messaging system 102 identifies the matching candidate profile 610 for the senior software engineer position by generating a search query using at least one of (a) the substitute terms or (b) the suggested keywords (i.e. required, relevant, or synonym keywords/skills associated with the job description). The automated search and personalized messaging system 102 executes the search query on the candidate search engine 110 to determine potential candidates for the Senior Software Engineer position. The candidate profile 610 of the matching candidates include at least one of skills, certification, experience, educational background, or career summary of the one or more matching candidate. The automated search and personalized messaging system 102 identifies the matched skills, experience, certification, or other parameters to determine the matching candidates for the senior software engineer position and to generate a personalized message for the matching candidates.

The automated search and personalized messaging system 102 analyses the candidate profile of the matching candidates with at least one of the job description, and the suggested keywords to generate the contextual message and the personalized message. In some embodiments, the contextual message describes how the candidates are suited for the target position. For example, I came across your impressive profile and experience as an Embedded Engineer at UVW. Our elite team is looking for a Senior Software Engineer to join our EV team in Canada. Your diverse skills and experience at UVW in component development and testing of diagnostics in vehicle based on the standards UDS ISO 14229, ISO 15765, CAN, Honda H99B using Renesas microcontrollers may be a fantastic addition to our team. Would you be interested in exploring this opportunity further?).

The automated search and personalized messaging system 102 generates a personalized message for the matching candidates. In some embodiments, the personalized message includes information related to how the candidates are suited for the target position and how the target position is matched with the candidate's preferences. For example, the automated search and personalized messaging system 102 generates a personalized message 602 for the matching candidates for the senior software engineer position. The personalized message 502 highlights the information related to how the candidate has suited for the target software engineer position orchestration position and how the target position is matched with the matching candidate preferences that are extracted from the candidate profile of the one or more matching candidate.

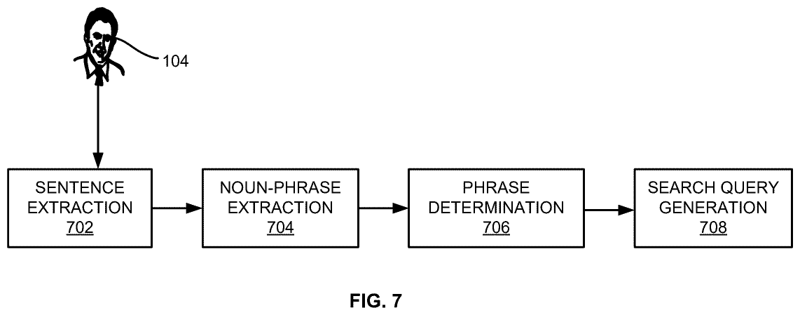

With reference to FIG. 1, FIG. 7 is an exemplary flow diagram of determining substitute terms for suggested keywords extracted from a job description according to some embodiments herein. At step 702, the automated search and personalized messaging system 102 extracts sentences from the job description provided by the recruiter 104. At step 704, the automated search and personalized messaging system 102 extracts noun phrases from the sentences. At step 706, the automated search and personalized messaging system 102 determines a phrase that is related to knowledge-based abilities by removing a phrase that is related to at least one of a degree, a relevant experience, a soft skill, a job title, an action verb, or a company and an organization. At step 708, the automated search and personalized messaging system 102 determines the substitute terms by grouping similar phrases related to the knowledge-based abilities. The automated search and personalized messaging system 102 combines the substitute terms using a Boolean expression to generate the search query.

In some embodiments, the large language model 108 is prompted with at least one of (a) the first curated question and the second curated question, (b) the first instruction and the second instruction, or (c) the first exemplary answer to the first curated question and the second exemplary answer to the second curated question to perform one or more tasks. For example, to extract a job title from a job description for a target position, the automated search and personalized messaging system 102 prompts the large language model 108 with at least one of (a) the first curated question and the second curated question, (b) the first instruction and the second instruction, or (c) the first exemplary answer to the first curated question and the second exemplary answer to the second curated question, for example, whether the text (e.g. software engineer as a job title) represents the job description and then the most common job titles are extracted. The automated search and personalized messaging system 102 uses the detailed job information, such as the title, company, location, and role information, which has been provided by the large language model 108 through the initial set of questions during query generation. This allows the system to efficiently manage various curated questions and perform specific tasks. In some embodiments, the automated search and personalized messaging system 102 labels the at least one of (a) the first curated question and the second curated question, (b) the first instruction and the second instruction, or (c) the first exemplary answer to the first curated question and the second exemplary answer to the second curated question related to a job title, and preferred or required skill of the job description. The automated search and personalized messaging system 102 may provide specific instructions to the large language model 108 for emphasizing the desired results (e.g. similar job tiles, similar skills) with its reasoning. The automated search and personalized messaging system 102 is provided with a job description, and a series of curated questions related to the job description which is then prompted to the large language model 108 to perform tasks, such as extracting job titles, identifying cities and states, determining remote work possibilities, and listing the relevant companies. The automated search and personalized messaging system 102 extracts sentences that describe the required and preferred skills, groups similar terms together, and collects other relevant information about the target position, such as degrees, certifications, benefits, and salary details. The curated question may be prompted to the large language model 108 are formulated to obtain specific information for use in preparing personalized messages.

In some embodiments, the automated search and personalized messaging system 102 performs a four-step process to extract at least one of the suggested keywords or the substitute terms from each sentence of the job description. The process includes copying each sentence of the job description, summarizing noun phrases from each sentence, removing irrelevant phrases from each sentence, and grouping similar phrases together to extract at least one of the suggested keywords or the substitute terms. Once at least one of the one or more suggested keywords or the substitute terms are obtained, the suitability of at least one of the suggested keywords or the substitute terms is assessed for search engine usage. In some embodiments, the automated search and personalized messaging system 102 employs a search simulator to determine a subset of the suggested keywords or the substitute terms that maintains its essence while generating substantial results (e.g., substitute terms). The search simulator ranks at least one of the suggested keywords or the substitute terms based on relevance and filters out phrases unrelated to the job description. The automated search and personalized messaging system 102 may consider several factors in the ranking/scoring process, such as at least one of the suggested keyword or the substitute term's frequency in the corpus, the prevalence of user queries, inverse document frequency, word count, presence in the job description, and relevance to the job description.

For example, the automated search and personalized messaging system 102 may extract a suggested keyword like “GPU programming,” from the job description. The automated search and personalized messaging system 102 then considers “GPU” as a suggested keyword and the “programming” part as irrelevant. Similarly, for the suggested keyword like “SQL queries,” the automated search and personalized messaging system 102 extracts the subset of each suggested keyword that maintains the meaning and generates the results (i.e. substitute terms/keywords having the same meaning). The automated search and personalized messaging system 102 determines terms/keywords that occur frequently in the corpus, and provides relevant results (i.e. substitute terms/keywords having the same meaning). The automated search and personalized messaging system 102 may rank phrases/terms higher if they align with frequently used recruiter phrases or in the corpus. In some embodiments, the automated search and personalized messaging system 102 uses an inverse document frequency factor to remove common words that appear frequently in the corpus. For example, if the target position is doctor, the automated search and personalized messaging system 102 identifies medical terms that are common in the job description for doctors but uncommon in other job descriptions. The automated search and personalized messaging system 102 considers factors such as certifications, skills, word count, the number of appearances in the job description, and whether the skill is present in the job title. By ranking and analyzing the phrases, the automated search and personalized messaging system 102 determines which substitute terms are relevant and generate results accordingly. In some embodiments, the automated search and personalized messaging system 102 identifies related phrases and ranks the entire expression to determine which substitute terms are required and which substitute terms are preferred.

The automated search and personalized messaging system 102 may employ the large language model 108 multiple times to extract relevant information and find related terms. The automated search and personalized messaging system 102 may also employ other methods to select a subset of related terms and then employ additional scoring techniques to rank the related terms. The automated search and personalized messaging system 102 determines which terms are required and which terms are preferred. After performing all these steps, there may be cases where enough results are not obtained when running the search query. To address this, the automated search and personalized messaging system 102 generates a required query, a preferred query, and a relaxed query with different combinations of required terms to ensure sufficient results. The automated search and personalized messaging system 102 may use the relaxed query that has less stringent words attached to it, to provide back more results that the user might not have thought of.

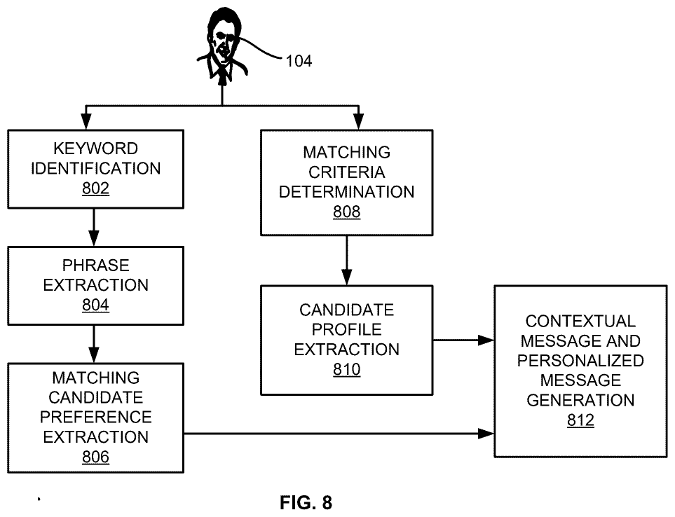

With reference to FIG. 1, FIG. 8 is an exemplary flow diagram of generating a contextual and personalized message according to some embodiments herein. The automated search and personalized messaging system 102 receives a job description and at least one of (a) the first curated question and the second curated question, (b) the first instruction and the second instruction, or (c) the first exemplary answer to the first curated question and the second exemplary answer to the second curated question from the recruiter 104. In some embodiments, the automated search and personalized messaging system 102 obtains at least one of (a) the suggested keywords or (b) the substitute terms extracted from the job requirement from the large language model 108. At step 802, the automated search and personalized messaging system 102 identifies keywords present in the candidate profile of the matching candidates that are matched with at least one of (a) a keyword or (b) a substitute term extracted from the job attribute. At step 804, the automated search and personalized messaging system 102 extracts one or more phrases from the candidate profile of the matching candidates based on the keywords present in the candidate profile of the matching candidates. At step 806, the automated search and personalized messaging system 102 extracts the matching candidate preferences from the candidate profile of the matching candidates by identifying a matching candidate preference present in the candidate profile of the matching candidates that is matched with at least one of (a) the keyword or (b) the substitute term extracted from the job attribute.

At step 808, the automated search and personalized messaging system 102 determines a matching attribute by identifying keywords from the candidate profile of the matching candidates that is matched with at least one of (a) the suggested keyword or (b) the substitute term extracted from the job requirement. At step 810, the automated search and personalized messaging system 102 extracts at least one of (a) a term, (b) a phrase, or (c) a sentence from the candidate profile of the matching candidates based on the one or more matching candidate preference that is identified. At step 812, the automated search and personalized messaging system 102 generates (i) the contextual message based on the matching attribute including (a) the keyword or (b) the substitute term extracted from the one or more job requirement that is matched with the keywords extracted from the candidate profile of the matching candidates and (ii) the personalized message on (A) how the candidates are suited for a target position associated with the job description using at least one of (a) the suggested keyword or (b) the substitute term extracted from the job requirement and (B) how the target position is matched with the matching candidate preference using at least one of (a) the term, (b) the phrase, or (c) the sentence extracted from the candidate profile of the matching candidate.

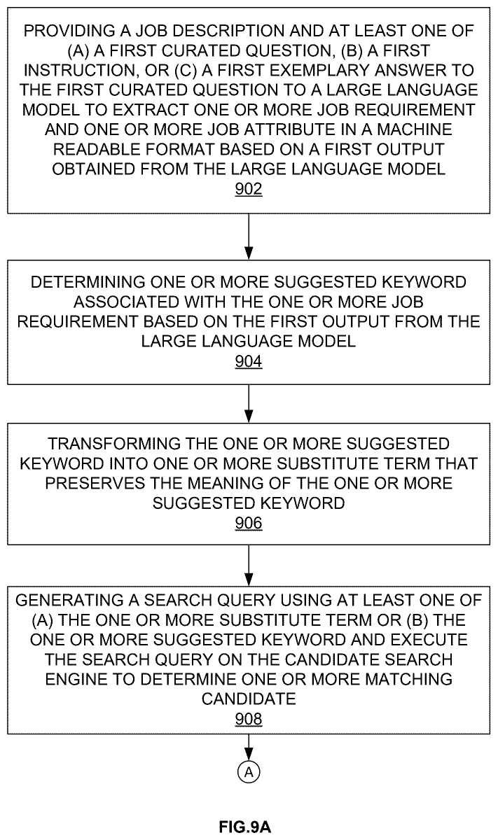

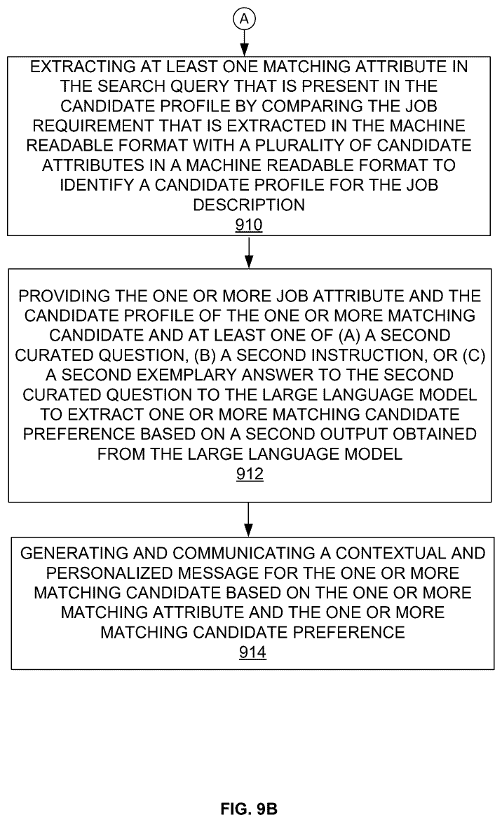

With reference to FIG. 1, FIG. 9 is a flow diagram that illustrates a method for automating search, identifying relevant candidates, and generating personalized messages using large language models according to some embodiments herein. At step 902, a job description and at least one of (a) the first curated question, (b) the first instruction, or (c) the first exemplary answer to the first curated question are provided to the large language model 108 to extract one or more job requirement and one or more job attribute in a machine-readable format based on a first output obtained from the large language model 108. At step 904, one or more suggested keyword associated with the one or more job requirement is determined based on the first output from the large language model 108. At step 906, the one or more suggested keyword is transformed into one or more substitute term that preserves the meaning of the one or more suggested keyword. The one or more substitute term is more likely to be found in the candidate profile than the one or more suggested keyword. At step 908, a search query is generated using at least one of (a) the one or more substitute term or (b) the one or more suggested keyword and executed on the candidate search engine to determine one or more matching candidate. The search query comprises a plurality of search terms separated by Boolean operators. At step 910, at least one matching attribute in the search query that is present in the candidate profile is extracted by comparing the job requirement that is extracted in the machine readable format with a plurality of candidate attributes in a machine readable format to identify a candidate profile for the job description. At step 912, the one or more job attribute and the candidate profile of the one or more matching candidate and at least one of (a) the second curated question, (b) the second instruction, or (c) the second exemplary answer to the second curated question are provided to the large language model to extract one or more matching candidate preference based on a second output obtained from the large language model. At step 914, a contextual and personalized message is generated and communicated for the one or more matching candidate based on the one or more matching attribute and the one or more matching candidate preference. The personalized message may include information related to why the candidate requires the target position. In some embodiments, the method enables the recruiter 104 to customize the personalized message and enables one or more actions related to the recruitment. The method trains the automated search and personalized messaging system 102 on historical data to understand which skills and qualifications are most important for the target position and which ones are less relevant. This enables the recruiter 104 to focus the search on the most important requirements and increase the chances of finding suitable candidates.

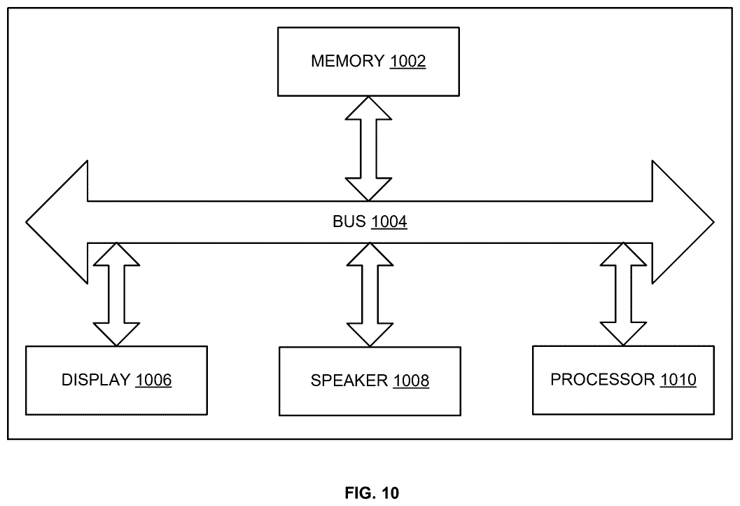

FIG. 10 illustrates an exploded view of the computing device/automated search and personalized messaging system 102 of FIG. 1 according to the embodiments herein. The computing device having a memory 1002 having a set of computer instructions, a bus 1004, a display 1006, a speaker 1008, and a processor 1010 capable of processing a set of instructions to perform any one or more of the methodologies herein, according to an embodiment herein. The processor 1010 may also enable digital content to be consumed in the form of a video for output via one or more displays 1006 or audio for output via speaker and/or earphones 1008. The processor 1010 may also carry out the methods described herein and in accordance with the embodiments herein.

The embodiments herein can take the form of, an entirely hardware embodiment, an entire software embodiment, or an embodiment including both hardware and software elements. The embodiments that are implemented in software include but are not limited to, firmware, resident software, microcode, etc. Furthermore, the embodiments herein can take the form of a computer program product accessible from a computer-usable or computer-readable medium providing program code for use by or in connection with a computer or any instruction execution system. For the purposes of this description, a computer-usable or computer-readable medium can be any apparatus that can include, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random access memory (RAM), a read-only memory (ROM), a rigid magnetic disk, and an optical disk. Current examples of optical disks include compact disk-read-only memory (CD-ROM), compact disk-read/write (CD-R/W) and DVD.

A data processing system suitable for storing and/or executing program code will include one or more processors coupled directly or indirectly to memory elements through a system bus. The memory elements can include local memory employed during the actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, remote controls, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem, and Ethernet cards are just a few of the currently available types of network adapters.

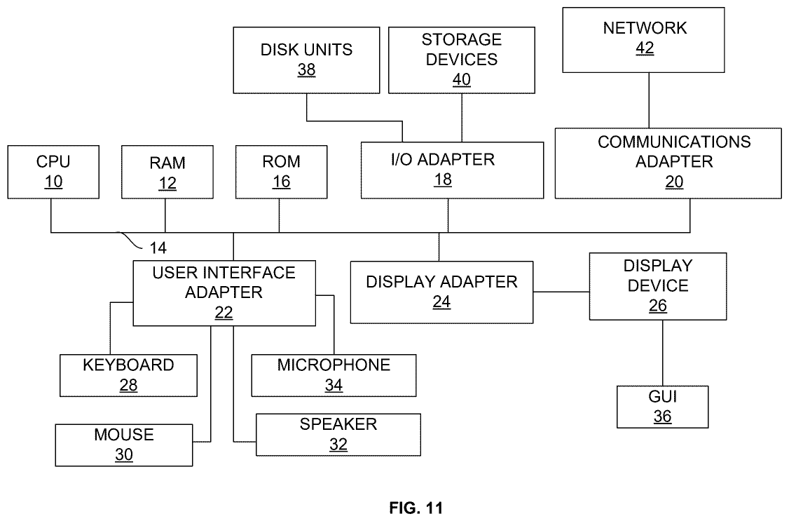

A representative hardware environment for practicing the embodiments herein is depicted in FIG. 11, with reference to FIGS. 1 through 10. This schematic drawing illustrates a hardware configuration of a server/computer system/computing device in accordance with the embodiments herein. The system includes one or more processing device CPU 10 that may be interconnected via system bus 14 to various devices such as a random-access memory (RAM) 12, read-only memory (ROM) 17, and an input/output (I/O) adapter 18. The I/O adapter 18 can connect to peripheral devices, such as disk units 38 and program storage devices 40 that are readable by the system. The system can read the inventive instructions on the program storage devices 40 and follow these instructions to execute the methodology of the embodiments herein. The system further includes a user interface adapter 22 that connects a keyboard 28, mouse 30, speaker 32, microphone 34, and/or other user interface devices such as a touch screen device (not shown) to the bus 14 to gather user input. Additionally, a communication adapter 20 connects the bus 14 to a data processing network 42, and a display adapter 24 connects the bus 14 to a display device 27, which provides a graphical user interface (GUI) 37 of the output data in accordance with the embodiments herein, or which may be embodied as an output device such as a monitor, printer, or transmitter, for example.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope.

What is claimed is:

1. A system for automating keyword search using Boolean operators on a candidate search engine to identify matching search result, the system comprising:
a memory;
a processor that is configured to
provide a description and at least one of (a) a first curated question, (b) a first instruction, or (c) a first exemplary answer to the first curated question to a large language model to extract at least one requirement and at least one attribute in a machine-readable format based on a first output obtained from the large language model;
determine at least one suggested keyword associated with the at least one requirement based on the first output from the large language model;
transform the at least one suggested keyword into at least one substitute term that preserves the meaning of the at least one suggested keyword, wherein the at least one substitute term is more likely to be found in a candidate profile than the at least one suggested keyword;
generate a search query using at least one of (a) the at least one substitute term or (b) the at least one suggested keyword and execute the search query on the candidate search engine to determine at least one matching candidate, wherein the search query comprises a plurality of search terms separated by Boolean operators; and
extract at least one matching attribute in the search query that is present in the candidate profile by comparing the requirement that is extracted in the machine readable format with a plurality of candidate attributes in a machine readable format to identify a matching search result.

2. The system of claim 1, wherein the processor is configured to generate the first curated question and the second curated question by parsing the description and extracting at least one phrase from the description using the large language model.

3. The system of claim 1, wherein the processor is configured to determine the at least one suggested keyword associated with the at least one requirement by executing the description and at least one of (a) the first curated question, (b) the first instruction, or (c) the first exemplary answer to the first curated question on the large language model, wherein the large language model determines the at least one suggested keyword from the at least one requirement using an answer to the first curated question that is generated based on the first instruction and the first exemplary answer to the first curated question provided to the large language model, wherein the at least one suggested keyword defines at least one of a required skill or a preferred skill.

4. The system of claim 1, wherein the processor is configured to determine the at least one substitute term for the at least one suggested keyword by
extracting at least one sentence from the description;
extracting at least one noun phrase from the at least one sentence;
determining a phrase that is related to knowledge-based abilities by removing a phrase that is related to at least one of a degree, a relevant experience, a soft skill, a title, an action verb, or a company and an organization; and
grouping similar phrases related to the knowledge-based abilities to determine the at least one substitute term and combining them using a Boolean expression to generate the search query.

5. The system of claim 1, wherein the processor is configured to generate the search query using the at least one suggested keyword, and the at least one substitute term, wherein the processor is configured to generate the search query using at least one of (i) the at least one suggested keyword or (ii) the at least one substitute term based on at least one of (a) a number of occurrences of the at least one substitute term in a corpus, the candidate profile, the description or (b) a number of occurrences of the at least one substitute term in a recruiter input.

6. The system of claim 1, wherein the processor is configured to generate the contextual message by
providing (i) the candidate profile of the at least one matching candidate, (ii) at least one of (a) the first curated question, (b) the first instruction, or (c) the first exemplary answer to the first curated question, and (iii) at least one of (a) the at least one suggested keyword or (b) the at least one substitute term extracted from the at least one requirement to the large language model;
determining, using the large language model, the at least one matching attribute by identifying one or more keywords from the candidate profile of the at least one matching candidate that is matched with at least one of (a) the at least one suggested keyword or (b) the at least one substitute term extracted from the at least one requirement; and
generating the contextual message based on the at least one matching attribute (a) the at least one keyword or (b) at least one the substitute term extracted from the at least one requirement that is matched with the one or more keywords extracted from the candidate profile of the at least one matching candidate.

7. The system of claim 1, wherein the processor is configured to provide the at least one attribute and the candidate profile of the at least one matching candidate and at least one of (a) a second curated question, (b) a second instruction, or (c) a second exemplary answer to the second curated question to the large language model to extract at least one matching candidate preference based on a second output obtained from the large language model; and
generate and communicate a contextual and personalized message for the at least one matching candidate based on the at least one matching attribute and the at least one matching candidate preference,
wherein the processor is configured to extract the at least one matching candidate preference by
analyzing the candidate profile of the at least one matching candidate to identify one or more keywords present in the candidate profile of the at least one matching candidate that is matched with at least one of (a) at least one keyword or (b) at least one substitute term extracted from the at least one attribute;
extracting, using the large language model, one or more phrases from the candidate profile of the at least one matching candidate based on the one or more keywords present in the candidate profile of the at least one matching candidate; and
extracting the at least one matching candidate preference from the candidate profile of the at least one matching candidate by identifying a matching candidate preference present in the candidate profile of the at least one matching candidate that is matched with at least one of (a) the at least one keyword or (b) the at least one substitute term extracted from the at least one attribute.

8. The system of claim 1, wherein the processor is configured to generate the personalized message by
analyzing the candidate profile of the at least one matching candidate to identify the at least one matching candidate preference present in the candidate profile of the at least one matching candidate that is matched with the at least one attribute;
extracting at least one of (a) a term, (b) a phrase, or (c) a sentence from the candidate profile of the at least one matching candidate based on the at least one matching candidate preference that is identified; and
generating the personalized message on (A) how the candidates are suited for a target position associated with the description using at least one of (a) the at least one suggested keyword or (b) the at least one substitute term extracted from the at least one requirement and (B) how the target position is matched with the at least one matching candidate preference using at least one of (a) the term, (b) the phrase, or (c) the sentence extracted from the candidate profile of the at least one matching candidate.

9. A computer-implemented method for automating keyword search using Boolean operators on a candidate search engine to identify a matching search result comprising:
providing a description and at least one of (a) a first curated question, (b) a first instruction, or (c) a first exemplary answer to the first curated question to a large language model to extract at least one requirement and at least one attribute in a machine-readable format based on a first output obtained from the large language model;
determining at least one suggested keyword associated with the at least one requirement based on the first output from the large language model;
transforming the at least one suggested keyword into at least one substitute term that preserves the meaning of the at least one suggested keyword, wherein the at least one substitute term is more likely to be found in a candidate profile than the at least one suggested keyword;
generating a search query using at least one of (a) the at least one substitute term or (b) the at least one suggested keyword and execute the search query on the candidate search engine to determine at least one matching candidate, wherein the search query comprises a plurality of search terms separated by Boolean operators; and
extracting at least one matching attribute the search query that is present in the candidate profile by comparing the requirement that is extracted in the machine readable format with a plurality of candidate attributes in a machine readable format to identify a matching search result.

10. The method of claim 9, wherein the at least one substitute term for the at least one suggested keyword is determined by
extracting at least one sentence from the description;
extracting at least one noun phrase from the at least one sentence;
determining a phrase that is related to knowledge-based abilities by removing a phrase that is related to at least one of a degree, a relevant experience, a soft skill, a title, an action verb, or a company and an organization; and
grouping similar phrases related to the knowledge-based abilities to determine the at least one substitute term and combining them using a Boolean expression to generate the search query.

11. The method of claim 9, wherein the search query is generated using at least one of (i) the at least one suggested keyword or (ii) the at least one substitute term based on at least one of (a) a number of occurrences of the at least one substitute term in a corpus, the candidate profile, the description or (b) a number of occurrences of the at least one substitute term in a recruiter input.

12. The method of claim 9, wherein the contextual message is generated by
providing (i) the candidate profile of the at least one matching candidate, (ii) at least one of (a) the first curated question, (b) the first instruction, or (c) the first exemplary answer to the first curated question, and (iii) at least one of (a) the at least one suggested keyword or (b) the at least one substitute term extracted from the at least one requirement to the large language model;
determining, using the large language model, the at least one matching attribute by identifying one or more keywords from the candidate profile of the at least one matching candidate that is matched with at least one of (a) the at least one suggested keyword or (b) the at least one substitute term extracted from the at least one requirement; and
generating the contextual message based on the at least one matching attribute comprising (a) the at least one keyword or (b) at least one the substitute term extracted from the at least one requirement that is matched with the one or more keywords extracted from the candidate profile of the at least one matching candidate.

13. The method of claim 9, wherein the method comprises
providing the at least one attribute and the candidate profile of the at least one matching candidate and at least one of (a) a second curated question, (b) a second instruction, or (c) a second exemplary answer to the second curated question to the large language model to extract at least one matching candidate preference based on a second output obtained from the large language model; and
generating and communicating a contextual and personalized message for the at least one matching candidate based on the at least one matching attribute and the at least one matching candidate preference,
wherein the at least one matching candidate preference is extracted by
analyzing the candidate profile of the at least one matching candidate to identify one or more keywords present in the candidate profile of the at least one matching candidate that is matched with at least one of (a) at least one keyword or (b) at least one substitute term extracted from the at least one attribute;
extracting, using the large language model, one or more phrases from the candidate profile of the at least one matching candidate based on the one or more keywords present in the candidate profile of the at least one matching candidate; and
extracting the at least one matching candidate preference from the candidate profile of the at least one matching candidate by identifying a matching candidate preference present in the candidate profile of the at least one matching candidate that is matched with at least one of (a) the at least one keyword or (b) the at least one substitute term extracted from the at least one attribute.

14. The method of claim 9, wherein the personalized message is generated by
analyzing the candidate profile of the at least one matching candidate to identify the at least one matching candidate preference present in the candidate profile of the at least one matching candidate that is matched with the at least one attribute;
extracting at least one of (a) a term, (b) a phrase, or (c) a sentence from the candidate profile of the at least one matching candidate based on the at least one matching candidate preference that is identified; and
generating the personalized message on (A) how the candidates are suited for a target position associated with the description using at least one of (a) the at least one suggested keyword or (b) the at least one substitute term extracted from the at least one requirement and (B) how the target position is matched with the at least one matching candidate preference using at least one of (a) the term, (b) the phrase, or (c) the sentence extracted from the candidate profile of the at least one matching candidate.

15. One or more non-transitory computer readable storage mediums storing one or more sequences of instructions for automating keyword search using Boolean operators on a candidate search engine to identify a matching search result, which when executed by one or more processors, cause:
providing a description and at least one of (a) a first curated question, (b) a first instruction, or (c) a first exemplary answer to the first curated question to a large language model to extract at least one requirement and at least one attribute in a machine-readable format based on a first output obtained from the large language model;
determining at least one suggested keyword associated with the at least one requirement based on the first output from the large language model;
transforming the at least one suggested keyword into at least one substitute term that preserves the meaning of the at least one suggested keyword, wherein the at least one substitute term is more likely to be found in a candidate profile than the at least one suggested keyword;
generating a search query using at least one of (a) the at least one substitute term or (b) the at least one suggested keyword and execute the search query on the candidate search engine to determine at least one matching candidate, wherein the search query comprises a plurality of search terms separated by Boolean operators; and
extracting at least one matching attribute in the search query that is present in the candidate profile by comparing the requirement that is extracted in the machine readable format with a plurality of candidate attributes in a machine readable format to identify a matching search result.

16. The one or more non-transitory computer-readable storage mediums of claim 15, wherein the at least one substitute term for the at least one suggested keyword is determined by
extracting at least one sentence from the description;
extracting at least one noun phrase from the at least one sentence;
determining a phrase that is related to knowledge-based abilities by removing a phrase that is related to at least one of a degree, a relevant experience, a soft skill, a title, an action verb, or a company and an organization; and
grouping similar phrases related to the knowledge-based abilities to determine the at least one substitute term and combining them using a Boolean expression to generate the search query.

17. The one or more non-transitory computer-readable storage mediums of claim 15, wherein the contextual message is generated by
providing (i) the candidate profile of the at least one matching candidate, (ii) at least one of (a) the first curated question, (b) the first instruction, or (c) the first exemplary answer to the first curated question, and (iii) at least one of (a) the at least one suggested keyword or (b) the at least one substitute term extracted from the at least one requirement to the large language model;
determining, using the large language model, the at least one matching attribute by identifying one or more keywords from the candidate profile of the at least one matching candidate that is matched with at least one of (a) the at least one suggested keyword or (b) the at least one substitute term extracted from the at least one requirement; and
generating the contextual message based on the at least one matching attribute comprising (a) the at least one keyword or (b) at least one the substitute term extracted from the at least one requirement that is matched with the one or more keywords extracted from the candidate profile of the at least one matching candidate.

18. The one or more non-transitory computer-readable storage mediums of claim 15, wherein the method comprises
providing the at least one attribute and the candidate profile of the at least one matching candidate and at least one of (a) a second curated question, (b) a second instruction, or (c) a second exemplary answer to the second curated question to the large language model to extract at least one matching candidate preference based on a second output obtained from the large language model; and
generating and communicating a contextual and personalized message for the at least one matching candidate based on the at least one matching attribute and the at least one matching candidate preference,
wherein the at least one matching candidate preference is extracted by
analyzing the candidate profile of the at least one matching candidate to identify one or more keywords present in the candidate profile of the at least one matching candidate that is matched with at least one of (a) at least one keyword or (b) at least one substitute term extracted from the at least one attribute;
extracting, using the large language model, one or more phrases from the candidate profile of the at least one matching candidate based on the one or more keywords present in the candidate profile of the at least one matching candidate; and
extracting the at least one matching candidate preference from the candidate profile of the at least one matching candidate by identifying a matching candidate preference present in the candidate profile of the at least one matching candidate that is matched with at least one of (a) the at least one keyword or (b) the at least one substitute term extracted from the at least one attribute.

19. The one or more non-transitory computer-readable storage mediums of claim 15, wherein the personalized message is generated by
analyzing the candidate profile of the at least one matching candidate to identify the at least one matching candidate preference present in the candidate profile of the at least one matching candidate that is matched with the at least one attribute;
extracting at least one of (a) a term, (b) a phrase, or (c) a sentence from the candidate profile of the at least one matching candidate based on the at least one matching candidate preference that is identified; and
generating the personalized message on (A) how the candidates are suited for a target position associated with the description using at least one of (a) the at least one suggested keyword or (b) the at least one substitute term extracted from the at least one requirement and (B) how the target position is matched with the at least one matching candidate preference using at least one of (a) the term, (b) the phrase, or (c) the sentence extracted from the candidate profile of the at least one matching candidate.
